(19) United States
(12) Patent Application Publication
(10) Pub. No.: US 2005/0240734 A1
(43) Pub. Date: Oct. 27, 2005

(54) Cache coherence protocol

(76) Inventors: Brannon J. Batson, Santa Cruz, CA (US); Ling Cen, Austin, TX (US); William A. Welch, San Jose, CA (US); Herbert Hum, Portland, OR (US); Seungjoon Park, Los Altos, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/833,977

(22) Filed: Apr. 27, 2004

(51) Int. Cl. G06F 12/00

(52) U.S. Cl. 711/141; 711/145

(57) ABSTRACT

A cache coherence protocol facilitates a distributed cache coherency conflict resolution in a multi-node system to resolve conflicts at a home node.

### FIELD

The invention relates to high-speed point-to-point link networks. More particularly, the invention relates to how a messaging protocol may be applied for implementing a coherent memory system with an interconnect architecture utilizing point-to-point links. For example, the described cache coherence protocol facilitates and supports systems ranging from a single-socket up through and greater than sixty four socket segments.

### BACKGROUND

When an electronic system includes multiple cache memories, the validity of the data available for use must be maintained. This is typically accomplished by manipulating data according to a cache coherency protocol. As the number of caches and/or processors increases, the complexity of maintaining cache coherency also increases.

When multiple components (e.g., a cache memory, a processor) request the same block of data the conflict between the multiple components must be resolved in a manner that maintains the validity of the data. Current cache coherency protocols typically have a single component that is responsible for conflict resolution. However, as the complexity of the system increases, reliance on a single component for conflict resolution can decrease overall system performance.

A messaging protocol defines a set of allowed messages between agents, such as, caching and home agents. Likewise, the messaging protocol allows for a permissive set of valid message interleavings. However, the messaging protocol is not equivalent to a cache coherence protocol. In contrast, the messaging protocol serves the purpose of establishing the “words and grammar of the language”. Consequently, the messaging protocol defines the set of messages that caching agents must send and receive during various phases of a transaction. In contrast to a messaging protocol, an algorithm (cache coherence protocol) is applied to a home agent for coordinating and organizing the requests, resolving conflicts, and interacting with caching agents.

There are two basic schemes for providing cache coherence, snooping (now often called Symmetric MultiProcessing SMP) and directories (often called Distributed Shared Memory DSM). The fundamental difference has to do with placement and access to the meta-information, that is, the information about where copies of a cache line are stored.

For snooping caches the information is distributed with the cached copies themselves, that is, each valid copy of a cache line is held by a unit that must recognize its responsibility whenever any node requests permission to access the cache line in a new way. Someplace—usually at a fixed location—is a repository where the data is stored when it is uncached. This location may contain a valid copy even when the line is cached. However, the location of this node is generally unknown to requesting nodes—the requesting nodes simply broadcast the address of a requested cache line, along with permissions needed, and all nodes that might have a copy must respond to assure that consistency is maintained, with the node containing the uncached copy responding if no other (peer) node responds.

For directory-based schemes, in addition to a fixed place where the uncached data is stored, there is a fixed location, the directory, indicating where cached copies reside. In order to access a cache line in a new way, a node must communicate with the node containing the directory, which is usually the same node containing the uncached data repository, thus allowing the responding node to provide the data when the main storage copy is valid. Such a node is referred to as the Home node.

The directory may be distributed in two ways. First, main storage data (the uncached repository) is often distributed among nodes, with the directory distributed in the same way. Secondly, the meta-information itself may be distributed, keeping at the Home node as little information as whether the line is cached, and if so, where a single copy resides. SCI, for example, uses this scheme, with each node that contains a cached copy maintaining links to other nodes with cached copies, thus collectively maintaining a complete directory.

Snooping schemes rely on broadcast, because there is no single place where the meta-information is held, so all nodes must be notified of each query, each node being responsible for doing its part to assure that coherence is maintained. This includes intervention messages, informing the Home node not to respond when another node is providing the data.

Snooping schemes have the advantage that responses can be direct and quick, but do not scale well because all nodes are required to observe all queries. Directory schemes are inherently more scalable, but require more complex responses, often involving three nodes in point-to-point communications.

### BRIEF DESCRIPTION OF THE DRAWINGS

The invention is illustrated by way of example, and not by way of limitation, in the figures of the accompanying drawings in which like reference numerals refer to similar elements.

FIG. 1 is an apparatus of a block of Tracker entries as utilized by one embodiment.

Table 1 comprises a plurality of Cmp_Fwd* types that are sent to an owner as utilized by one embodiment.

Table 2 provides one embodiment for a plurality of home agent responses for a first type of conflict list.

Table 3 provides one embodiment for a plurality of home agent responses for a second type of conflict list.

FIG. 2 depicts a protocol flow for a conflict case as utilized by one embodiment.

FIG. 3 depicts a protocol flow for a RspFwd ordering as utilized by one embodiment.

FIG. 4 depicts multiple systems as utilized by multiple embodiments.

### DETAILED DESCRIPTION

Techniques for a cache coherence protocol are described. For example, this cache coherence protocol is one example of a two-hop protocol that utilizes a messaging protocol from referenced application P18890 that is applied for implementing a coherent memory system using agents in a network fabric. One example of a network fabric may comprise either or all of: a link layer, a protocol layer, a routing layer, a transport layer, and a physical layer. The fabric facilitates transporting messages from one protocol (home or caching agent) to another protocol for a point to point network. In one aspect, the figure depicts a cache coherence protocol's abstract view of the underlying network.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

As previously noted, the claimed subject matter incorporates several innovative features from the related applications. For example, the claimed subject matter references the Forward state (F-state) from the related application entitled SPECULATIVE DISTRIBUTED CONFLICT RESOLUTION FOR A CACHE COHERENCY PROTOCOL. Likewise, the claimed subject matter utilizes conflict tracking at the home agent for various situations, which is discussed in connection with application P15925, filed concurrently with this application and entitled “A TWO-HOP CACHE COHERENCY PROTOCOL”. Finally, the claimed subject matter utilizes various features of applying the messaging protocol depicted in application P18890), filed concurrently with this application and also entitled “A Messaging Protocol”. However, various features of the related applications are utilized throughout this application and we will discuss them as needed. The preceding examples of references were merely illustrative.

The discussion that follows is provided in terms of nodes within a multi-node system. In one embodiment, a node includes a processor having an internal cache memory, an external cache memory and/or an external memory. In an alternate embodiment, a node is an electronic system (e.g., computer system, mobile device) interconnected with other electronic systems. Other types of node configurations can also be used.

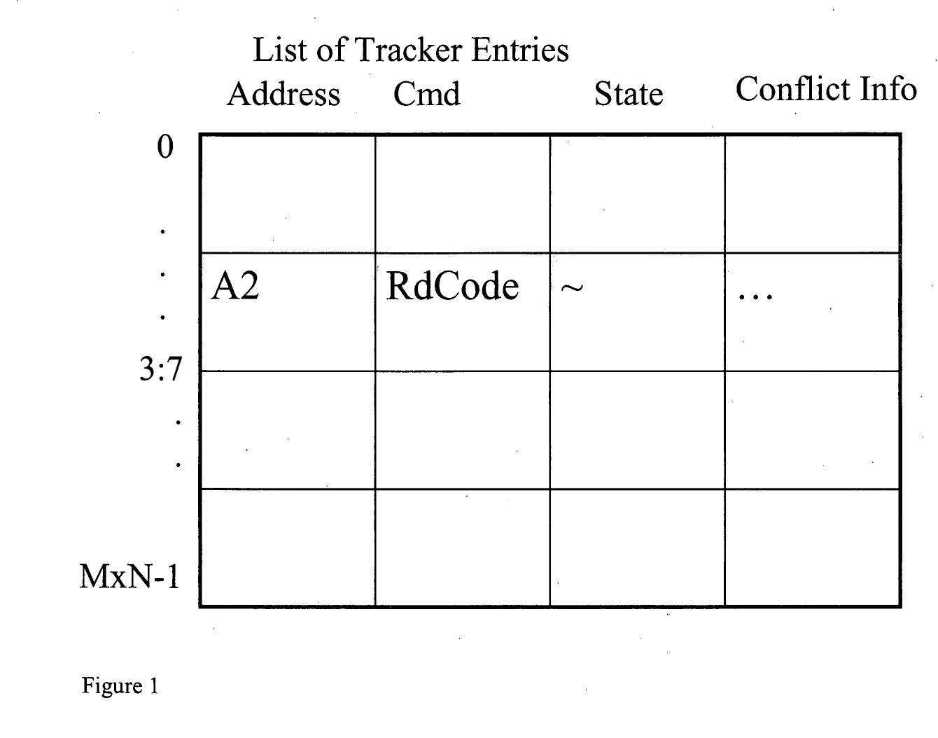

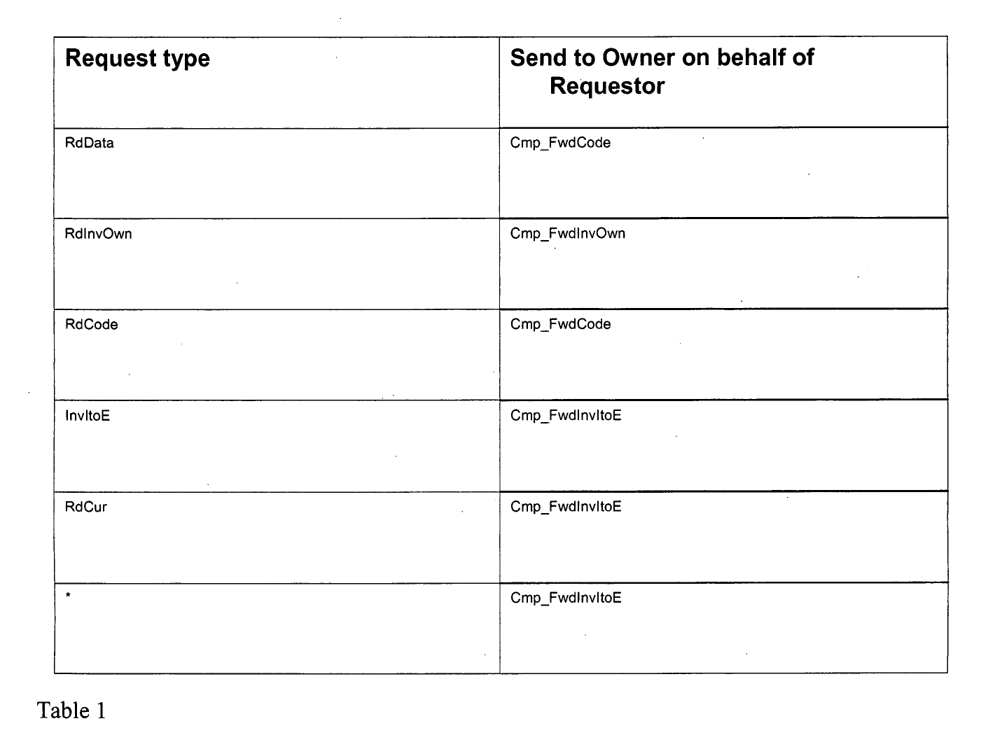

In one embodiment, a cache coherence protocol utilized with the described messaging protocol from P18890, defines the operation of two agent types, a caching agent and a home agent. For example, FIG. 1 of P18890 depicted a protocol architecture as utilized by one embodiment. The architecture depicts a plurality of caching agents and home agents coupled to a network fabric. For example, the network fabric may comprise either or all of: a link layer, a protocol layer, a routing layer, a transport layer, and a physical layer. The fabric facilitates transporting messages from one protocol (home or caching agent) to another protocol for a point to point network. In one aspect, the figure depicts a cache coherence protocol's abstract view of the underlying network.

As previously discussed in the messaging protocol of P18890, FIG. 1 of that application depicts a cache coherence protocol's abstract view of the underlying network.

In this embodiment, the caching agent:
1) makes read and write requests into coherent memory space
2) hold cached copies of pieces of the coherent memory space
3) supplies the cached copies to other caching agents.

Also, in this embodiment, the home agent guards a piece of the coherent memory space and performs the following duties:
1) tracking cache state transitions from caching agents
2) managing conflicts amongst caching agents
3) interfacing to a memory, such as, a dynamic random access memory (DRAM)
4) providing data and/or ownership in response to a request (if the caching agent has not responded).

For example, the cache coherence protocol depicts a protocol for the home agent that allows the home agent to sink all control messages without a dependency on the forward progress of any other message.

In one embodiment, the following depicts one combination of assumptions for the cache coherence protocol. As previously described in P18890, each caching agent utilizes a PeerAgent parameter. Furthermore, each caching agent's PeerAgent parameter is configured for the respective caching agent to perform a snoop on all of the other caching agents on a request. Another assumption is a home virtual channel is strictly ordered per address from each caching agent to each home agent. In yet another assumption, a home agent has a Tracker entry that contains state information that is relevant to the transaction. The Tracker entry is discussed in further detail in connection with FIG. 1.

FIG. 1 is an apparatus of a block of Tracker entries as utilized by one embodiment. In one embodiment, the block of Tracker entries resides in a home agent. Likewise, there is a tracker entry for each possible simultaneous outstanding request in the respective home agent. In one embodiment, the tracker entry exists for each possible simultaneous outstanding request across all caching agents to that respective home agent. Therefore, there is one Tracker entry in a home agent for each valid Unique Transaction Identifier (UTID) across the nodes in the system. In one embodiment, the tracker entry comprises the following information for the request: an address, Cmd, and some degree of dynamic state related to the request. For example, the state required for tracking conflicts (labeled as Conflict info in the header of the column) is proportional to the number of snoops that may conflict with each request, hence, they may vary under various system configurations.

In one embodiment, the claimed subject matter depicts a cache coherence protocol that defines ordering rules. For example, one ordering rule is upon a request receiving a RspFwd* or Rsp*Wb (discussed in P18890), that respective request should be ordered in front of all subsequent requests to the same address. Another example of an ordering rule that may be applied is that for RspFwd* or Rsp*Wb messages that do not carry an address, the home agent orders that request in front of all requests to all addresses. For the previous ordering rule, in one embodiment, the home agent guarantees that the respective request is ordered in front of all requests to all addresses because the request message is not guarantee to arrive before the RspFwd*. Another example of an ordering rule that may be applied is that a Rsp*Wb message blocks progress on subsequent conflicting requests until the accompanying Wb*Data* has arrived and committed to memory. Another example of an ordering rule that may be applied is that either RspFwd* or Rsp*Wb blocks progress on subsequent requests until it has received all of its other snoop responses and request message, and it has sent out a Cmp to the requestor.

A transaction A is removed from the conflict relation when the home receives an AckCnflt from A. To remove A from the conflict relation, the conflict lists are modified as follows:
For any B not equal to C in A's conflict list, make B and C in conflict with each other.
For any B in A's conflict list, A is removed from B's conflict list.

A's conflict list is emptied. Caching agents (also called peer agents) generate transactions. Each transaction has a unique identifier (UTID). In order to determine if a transaction is equal to another transaction, one needs to compare their respective Unique Transaction Identifiers (UTID). If so, they are identical. Otherwise, they are not equal.

As previously discussed, an cache coherence protocol is an algorithm that is applied to a home agent for coordinating and organizing the requests, resolving conflicts, and interacting with caching agents. The following Tables 1-3 are one embodiment of defining an algorithm for the cache coherence protocol.

Table 1 comprises a plurality of Cmp_Fwd* types that are sent to an owner as utilized by one embodiment. In one embodiment, either one of the following events occurs upon a home agent receiving an AckCnflt message.

One event occurs as follows. If no conflictor of A has received a response from A, hence, none of A's conflictors is a true conflictor. Consequently, the home agent sends a Cmp message to A. In one embodiment, this event occurs for preventing deadlock because the snoops of A's conflictors would have been buffered or blocked upon reaching A.

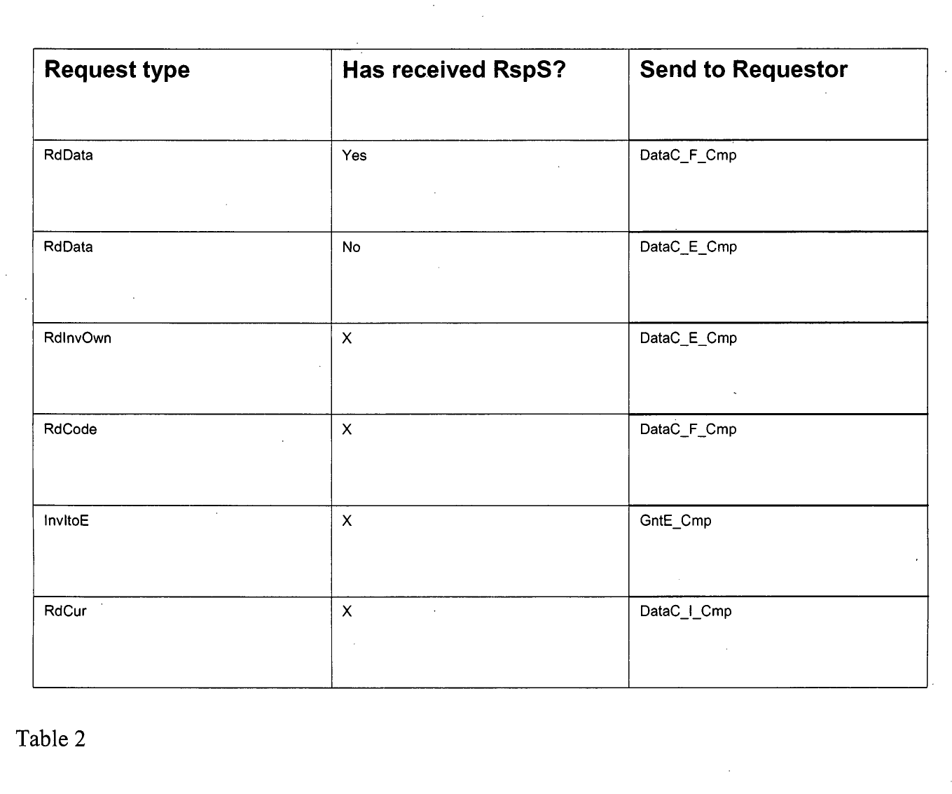

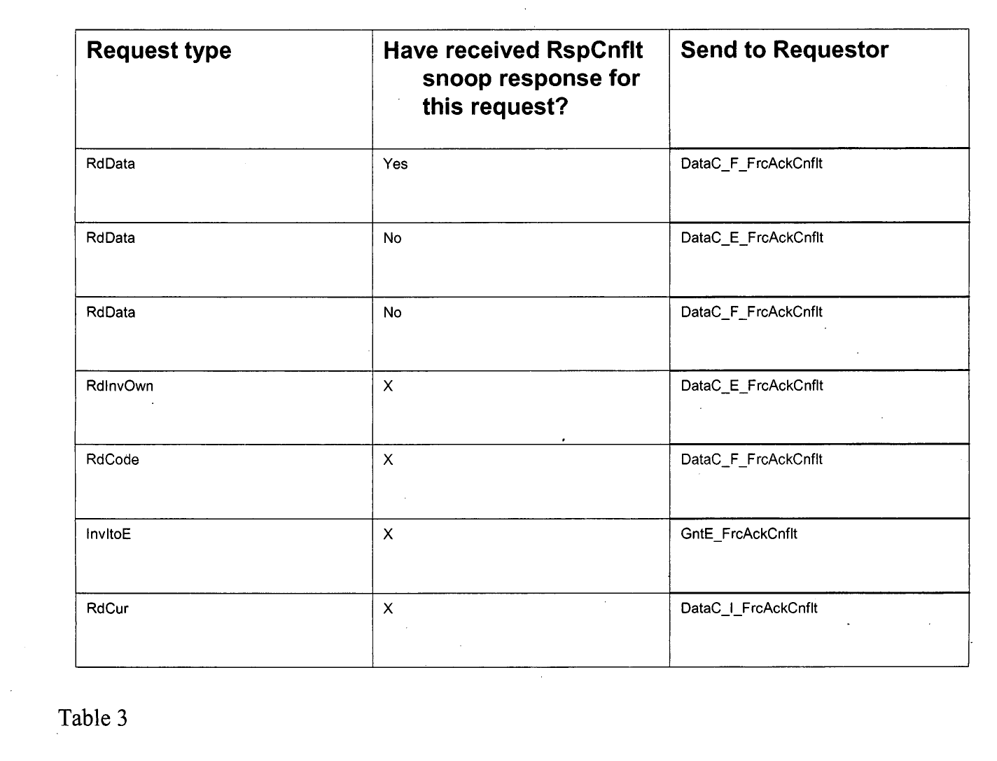

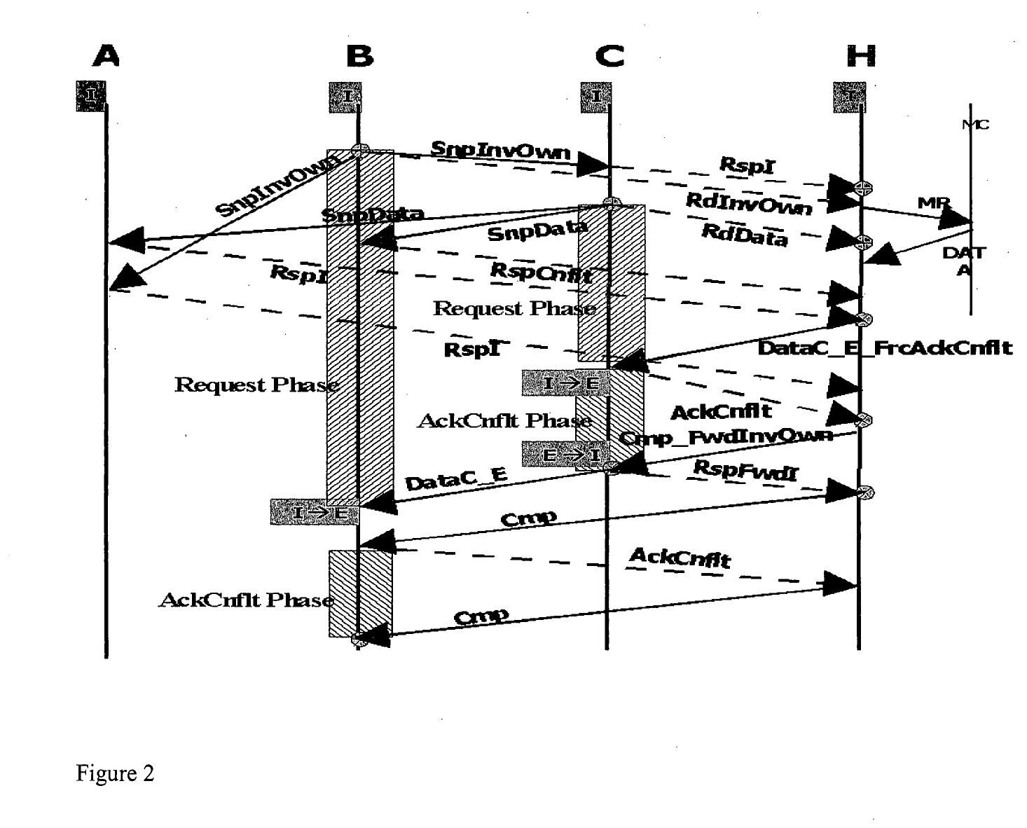

Another event occurs as follows. If at least one conflictor of A, for example, B, has received a response from A, consequently, a Cmp_Fwd* is sent to A on behalf of B based at least in part on Table 1. As previously described, Table 1 comprises a plurality of Cmp_Fwd* types that are sent to an owner on behalf of the requestor as utilized by one embodiment. In one embodiment, the Cmp_Fwd* does not wait for all of B's snoop responses. For example, in one embodiment, this can introduce deadlock under snoop blocking. However, it may wait for B's request, but this is not necessary: a Cmp_FwdInvItoE may be sent before B's request type is known. The selection of B, on the one hand, may not violate any ordering constraints captured so far (see FIGS. 1 and 2), as B may be the next requestor to obtain data in the conflict chain. On the other hand, the selection of B may not commit the home to completing B next in terms of transaction ordering either, as the early sending of Cmp_Fwd* (i.e., B may not have received all its snoop responses) means that there may be ordering constraints that the home is not yet aware of.

In one embodiment, the home agent may generate either a completion or data+completion response for a transaction A when the following conditions are met:
1. The home has received A's request and, if A is not a WbMto*, all its peers' responses.
2. A is not ordered behind any other transaction to the same address according the ordering rules.
3. None of A's conflictors is waiting for an AckCnflt. For example, in one embodiment, this condition ensures that no Cmp_Fwd* need be sent on behalf of A and, if a data response is needed, the data can be obtained from memory.
4. If there has been an explicit (WbMto*) or implicit (Rsp*Wb) writeback, the writeback data has been committed to memory.
   If all of the above conditions are met, consequently, the home sends to A a completion response (Cmp or FrcAckCnflt) if A is a WbMto* or has received an implicit forward. In one embodiment, an implicit forward is a case in which data is forwarded from one node directly to another in response to a snoop message, potentially before the home agent as observed this request at all. Thus, caching agents can send snoops directly to other caching agents and receive the data responses without home intervention.

Otherwise, a data+completion response is sent according to Table 2 or Table 3. Table 2 provides one embodiment for a plurality of home agent responses for a first type of conflict list. Table 3 provides one embodiment for a plurality of home agent responses for a second type of conflict list. For example, Table 2 depicts home agent responses if the particular conflict list is empty. In contrast, Table 3 depicts home agent responses if the particular conflict list is not empty. Based on each Table, and whether there has been a RspS* message or RspCnflt snoop response for this request, a message is sent to the requestor. The message is depicted in the right hand column of each table.

Continuing on with the previous paragraph for the response based on whether the A's conflict is empty, the *Cmp response is used when A's conflict list is empty and *FrcAckCnflt response is used when it is not. An exception to the last rule is that a Cmp response may always be sent to a WbMto*, because if a WbMto* is in conflict with any other request, it must have sent a RspCnflt and hence will respond to the Cmp with AckCnflt.

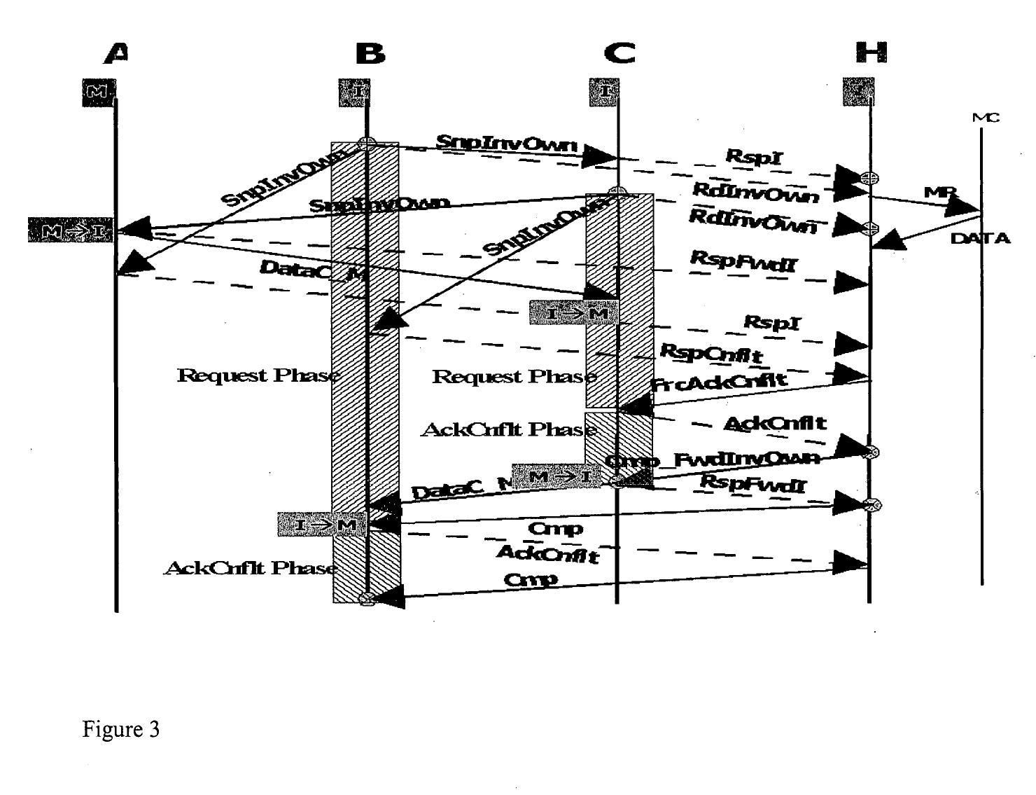

FIG. 2 depicts a protocol flow for a conflict case as utilized by one embodiment. In order to appreciate the protocol flows depicted in FIG. 2 and FIG. 3, the following is provided to serve as a legend for reading the flowchart. The letters, A, B, and C indicate requestor caching agents, in contrast, the letter H indicates a home agent and MC indicates a Memory controller. In one embodiment, a green circle with a cross symbol indicates either to allocate requestor entry or home agent tracking entry. In contrast, a yellow circle with a x symbol indicates to deallocate requestor entry or home agent tracking entry. Furthermore, a dashed line from one node to a home agent (H) is an ordered home channel message. As previously described for one embodiment, an ordered channel refers to a channel that may be between the same pair of nodes in a similar direction to insure that a first message from a requesting node that was sent before a second message from the same requesting node is received in that order (first message is received first by the receiving node and the second message is subsequently received by the receiving node). In contrast, a solid line from one node to a home agent (H) is an unordered probe or response channel message. Finally, the various letters at the end of each phase indicate the state of the cache line (MESIF states as previously described and in reference to the cross referenced patent applications.

However, the claimed subject matter is not limited to three caching agents, A, B, and C, with a home agent and memory controller. The protocol flows depicted in FIGS. 2 and 3 merely represent one embodiment. One skilled in the art appreciates utilizing different combinations of caching agents, ordered channels and different timing diagrams.

FIG. 2 depicts a scenario where a FrcAckCnflt is utilized to resolve a potential conflict. For example, in one embodiment, a FrcAckCnflt allows the home agent to signal a potential conflict to the cache agent owner. Also, in one embodiment, a FrcAckCnflt may be generated when a request has a non-empty conflict list. For example, conflicting Unique Transaction Identifiers (UTID) have not been cleared by matching AckCnflt.

In the following flow depicted in FIG. 2, a conflicting snoop is processed at caching agent C before C's request is generated. To set the scenario, the home agent H detects a conflict because C's request has received a RspCnflt snoop response from B, however, the caching agent C ha snot been hit by a snoop during its request phase. In order to resolve this, the home agent issues a DataC_E_FrcAckCnflt (in contrast to a DataC_E_Cmp) to caching agent C, subsequently, caching agent C sends an AckCnflt response to the home agent H. The home agent proceeds with a normal conflict resolution since AckCnflt causes the home agent to chose a conflictor. In this example, B is chosen to be the next owner, subsequently, the home agent sends a Cmp_FwdInvOwn to caching agent C on caching agent B's behalf.

FIG. 3 depicts a protocol flow for a RspFwd ordering as utilized by one embodiment. As previously discussed, in one embodiment, the claimed subject matter depicts a cache coherence protocol that defines ordering rules. For example, one ordering rule is upon a request receiving a RspFwd* or Rsp*Wb (discussed in P18890), that respective request should be ordered in front of all subsequent requests to the same address. Another example of an ordering rule that may be applied is that for RspFwd* or Rsp*Wb messages that do not carry an address, the home agent orders that request in front of all requests to all addresses. For the previous ordering rule, in one embodiment, the home agent guarantees that the respective request is ordered in front of all requests to all addresses because the request message is not guarantee to arrive before the RspFwd*. Another example of an ordering rule that may be applied is that a Rsp*Wb message blocks progress on subsequent conflicting requests until the accompanying Wb*Data* has arrived and committed to memory. Another example of an ordering rule that may be applied is that either RspFwd* or Rsp*Wb blocks progress on subsequent requests until it has received all of its other snoop responses and request message, and it has sent out a Cmp to the requestor.

FIG. 3 depicts one example of a RspFwd ordering scenario. To set the foundation for this example, please note caching agent B receives its request and all its snoop responses at the home agent H before caching agent C. However, C's request should be ordered in front of B's request because C has received the latest data on a cache to cache transfer from caching agent A (DataC_M from A to C). Since the conflict might not arrive before B receives all of its snoop responses, we need perform a reorder. Therefore, the claimed subject matter facilitates recording some global state across requests to a given address such that subsequent requests to that address are impeded until the RspFwd* request is completed. Furthermore, the RspFwd* may arrive before the request has generated it, hence, the full address may not be available for a strict per-address ordering. However, the global state can be recorded at an arbitrarily coarse granularity with respect to address, consequently, this impeded progress on requests to a different address.

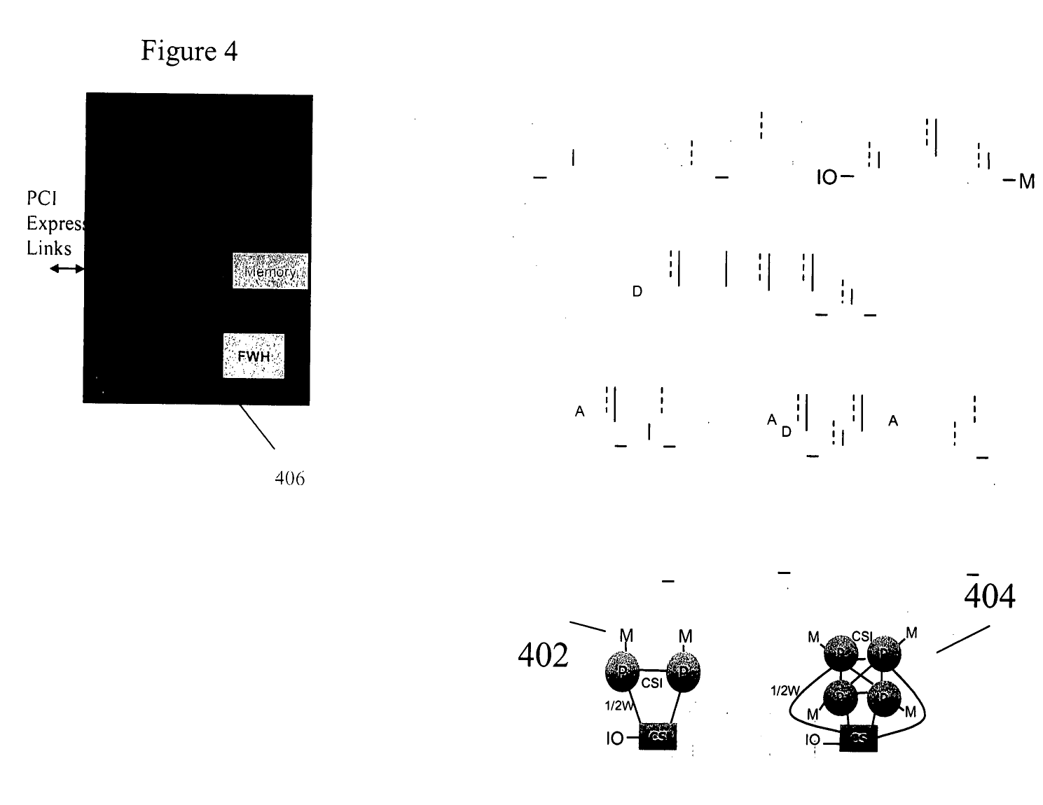

FIG. 4 depicts a point to point system with one or more processors. The claimed subject matter comprises several embodiments, one with one processor 406, one with two processors (P) 402 and one with four processors (P) 404. In embodiments 402 and 404, each processor is coupled to a memory (M) and is connected to each processor via a network fabric may comprise either or all of: a link layer, a protocol layer, a routing layer, a transport layer, and a physical layer. The fabric facilitates transporting messages from one protocol (home or caching agent) to another protocol for a point to point network. As previously described, the system of a network fabric supports any of the embodiments depicted in connection with FIGS. 1-3 and Tables 1-3.

For embodiment 406, the uni-processor P is coupled to graphics and memory control, depicted as IO+M+F, via a network fabric link that corresponds to a layered protocol scheme. The graphics and memory control is coupled to memory and is capable of receiving and transmitting via PCI Express Links. Likewise, the graphics and memory control is coupled to the ICH. Furthermore, the ICH is coupled to a firmware hub (FWH) via a LPC bus. Also, for a different uni-processor embodiment, the processor would have external network fabric links. The processor may have multiple cores with split or shared caches with each core coupled to a Xbar router and a non-routing global links interface. Thus, the external network fabric links are coupled to the Xbar router and a non-routing global links interface.

Although the claimed subject matter has been described with reference to specific embodiments, this description is not meant to be construed in a limiting sense. Various modifications of the disclosed embodiment, as well as alternative embodiments of the claimed subject matter, will become apparent to persons skilled in the art upon reference to the description of the claimed subject matter. It is contemplated, therefore, that such modifications can be made without departing from the spirit or scope of the claimed subject matter as defined in the appended claims.

1. A cache coherence protocol for a plurality of cache agents and a plurality of home agents comprising:
the plurality of caching agents utilize a peer agent parameter;
a home virtual channel is strictly ordered per address from each of the plurality of caching agents to each of the plurality of home agents;
a home agent has a tracker entry that contains state information that is relevant to a transaction.

2. The cache coherence protocol of claim 1 wherein the peer agent parameter is configured for the respective caching agent to perform a snoop on all of the other caching agents on a request.

3. The cache coherence protocol of claim 1 wherein the plurality of cache agents and the plurality of home agents are coupled via a network fabric.

4. The cache coherence protocol of claim 1 wherein the network fabric adheres to a layered protocol scheme.

5. The cache coherence protocol of claim 1 wherein the layered protocol scheme comprises at least one of a link layer, a protocol layer, a routing layer, a transport layer, and a physical layer.

6. An apparatus for a tracker entry for a cache coherence protocol for a plurality of cache agents and a plurality of home agents comprising:
a plurality of tracker entries residing in the plurality of home agents;
each one of the plurality of tracker entries for each possible simultaneous outstanding request in the respective home agent.

7. The apparatus of claim 6 wherein the tracker entry exists for each possible simultaneous outstanding request across all of the plurality of caching agents to that respective home agent, such that there is one tracker entry in a home agent for each valid Unique Transaction Identifier (UTID) across a plurality of nodes in a system.

8. The apparatus of claim 6 wherein the tracker entry comprises the following information for the simultaneous outstanding request:
an address; a Cmd, and a dynamic state based at least in part on the simultaneous outstanding request.

9. The apparatus of claim 6 wherein the dynamic state required for tracking conflicts is proportional to a number of snoops that may conflict with each request and vary under various system configurations.

10. A cache coherence protocol for a plurality of cache agents and a plurality of home agents that defines a plurality of ordering rules comprising:
a first ordering rule that a request receiving a predetermined response message, if so, that respective request should be ordered in front of all subsequent requests to the same address;
a second ordering rule is for the predetermined response message that does not carry an address, one of the plurality of home agents orders that request in front of all requests to all addresses.

11. The cache coherence protocol further comprising:
a third ordering rule for a predetermined message allows for blocking progress on subsequent conflicting requests until an predetermined writeback message has arrived and committed to a memory;
a forth ordering rule for a predetermined response message allows blocking progress on subsequent requests until it has received all of its other snoop responses and request messages, and it has sent out a Cmp message to a requestor.

12. A cache coherence protocol of claim 10 wherein the predetermined response message is either a RspFwd* or Rsp*Wb.

13. A cache coherence protocol of claim 11 wherein the predetermined writeback message is a Wb*Data message.

14. A cache coherence protocol of claim 11 wherein the predetermined response message is either a RspFwd* or Rsp*Wb.

15. A cache coherence protocol of claim 10 wherein for the second ordering rule the home agent guarantees that the respective request is ordered in front of all requests to all addresses because the request message is not guarantee to arrive before the RspFwd* message.

16. A cache coherence protocol of claim 11 the predetermined writeback message is a Wb*Data* message.

17. A cache coherence protocol as applied to a messaging protocol for a plurality of caching agents and a plurality of home agents coupled via a network fabric comprising:
the messaging protocol to support the plurality of caching agents support to support MESIF cache states and at least one of the plurality of home agents to determine a winner of conflict for an address among at least two of the plurality of caching agents and at least one of the plurality of home agents to request the data from an owner to be sent to the winner; and
the cache coherence protocol to allow at least one of the plurality of home agents to sink all control messages without a dependency on a forward progress of any other message.

18. The cache coherence protocol of claim 17 wherein the network fabric adheres to a layered protocol scheme.

19. The cache coherence protocol wherein the layered protocol scheme comprises at least one of a link layer, a protocol layer, a routing layer, a transport layer, and a physical layer.

20. The cache coherence protocol of claim 17 wherein at least one of the plurality of caching agents acknowledges the conflict by sending an AckCnflt message to at least one of the plurality of home agents.

21. A cache coherence protocol as applied to a messaging protocol for a plurality of caching agents and a plurality of home agents coupled via a network fabric comprising:
at least one of the plurality of home agents to generate either a completion or data/completion response for a transaction A when the following condition is met:
the respective home agent has received transaction A's request and, if A is not a predetermined writeback messages and all of the respective plurality of caching agent's responses.

22. The cache coherence protocol of claim 21 wherein the predetermined writeback message is a Wb Mto* message.

23. The cache coherence protocol of claim 21 wherein to generate either the completion or data/completion response for the transaction A when the following condition is met further comprising:
the transaction A is not ordered behind any other transaction to same address;
none of transaction A's conflictors is waiting for an predetermined acknowledgment conflict message;
and if there has been an explicit writeback message or implicit response writeback message wherein a writeback data has been committed to memory.

24. The cache coherence protocol of claim 21 wherein upon satisfying the conditions for generating the completion or data/completion response for a transaction A the respective home agent to send a completion response.

25. A cache coherence protocol to allow at least one of a plurality of home agents to resolve a potential conflict among a plurality of caching agents comprising:
an acknowledgement conflict message is either;
generated to indicate a potential conflict to one of the plurality of cache agents that is a respective owner;
or when a request has a non-empty conflict list.

26. The cache coherence protocol of claim 24 wherein the plurality of cache agents and the plurality of home agents are coupled via a network fabric.

27. The cache coherence protocol of claim 25 wherein the network fabric adheres to a layered protocol scheme.

28. The cache coherence protocol of claim 26 wherein the layered protocol scheme comprises at least one of a link layer, a protocol layer, a routing layer, a transport layer, and a physical layer.

29. A system comprising:
a processor configuration of at least one processor to support network fabric links to a network fabric of a plurality of caching agents and a plurality of home agents;
the plurality of caching agents support to support MESIF cache states and at least one of the plurality of home agents to determine a winner of conflict for an address among at least two of the plurality of caching agents;
at least one of the plurality of home agents to request the data from an owner to be sent to the winner; and
the plurality of caching agents utilize a peer agent parameter.

30. The system of claim 28 wherein the processor configuration of a single processor is coupled to graphics and memory control via a network fabric link that corresponds to a layered protocol scheme.

31. The system of claim 28 wherein the processor configuration of a single processor with external network fabric links.

32. The system of claim 28 wherein the processor has multiple cores with either split or shared caches.

33. The system of claim 28 wherein the processor has multiple cores with either split or shared caches.

34. A system comprising:
a processor configuration of at least one processor to support network fabric links to a network fabric of a plurality of caching agents and a plurality of home agents;
the plurality of caching agents support to support MESIF cache states and at least one of the plurality of home agents to determine a winner of conflict for an address among at least two of the plurality of caching agents;
at least one of the plurality of home agents to request the data from an owner to be sent to the winner; and
a home virtual channel is strictly ordered per address from each of the plurality of caching agents to each of the plurality of home agents.

35. The system of claim 33 wherein the processor configuration of a single processor is coupled to graphics and memory control via a network fabric link that corresponds to a layered protocol scheme.

36. The system of claim 33 wherein the processor configuration of a single processor with external network fabric links.

37. The system of claim 33 wherein the processor has multiple cores with either split or shared caches.

38. The system of claim 33 wherein the processor has multiple cores with either split or shared caches.
